(19) United States
(12) Patent Application Publication
(10) Pub. No.: US 2024/0403944 A1
(43) Pub. Date: Dec. 5, 2024

(54) Web-Based Platform for the Delivery and Distribution of Educational Materials

(71) Applicant: Andrew Nelson Lang, Warren, PA (US)

(72) Inventor: Andrew Nelson Lang, Warren, PA (US)

(21) Appl. No.: 18/800,818

(22) Filed: Aug. 12, 2024

Related U.S. Application Data
(63) Continuation of application No. 17/861,289, filed on Jul. 11, 2022.
Application No. 17/861,289 is a division of application No. 16/008,647, filed on Jun. 14, 2018, now abandoned.
(60) Provisional application No. 62/521,133, filed on Jun. 16, 2017.

(51) Int. Cl. G06Q 30/0601; G06Q 50/20; G09B 5/02; H04L 67/50

(52) U.S. Cl. CPC G06Q 30/0641; G06Q 50/20; G09B 5/02; H04L 67/535

(57) ABSTRACT

A web-based platform for improvement of education including a platform that is suitable for delivery and distribution of educational materials, a platform for taking notes, a platform for gathering data and analytics on the performance of learners, and an assessment of learning.

### CROSS-REFERENCE

This application is a divisional of U.S. patent application Ser. No. 16/008,647 filed Jun. 14, 2018, which claims the benefit of U.S. Provisional Application No. 62/521,133, filed Jun. 16, 2017, all of which are incorporated herein by reference.

### BACKGROUND OF THE INVENTION

Currently, instructors and students are forced to rely on technologies such as email or in-person meetings when they wish to interact with each other. Presently and commonly available technologies attempt to overcome these limitations through various methods, however, the current platforms suffer from critical defects by being too cumbersome and inefficient to the end-users. Additionally, current platforms do not provide an efficient mechanism for the sharing of educational materials between instructors, students, and other users because current platforms focus on one-way learning where the instructor has all the access for sharing and distribution of material while limiting student interaction to traditional electronic correspondence or in-person meetings.

A need exists for a web-based platform for delivery and distribution of educational materials presents opportunities for students, instructors, and other users to connect in a robust manner, unlike any other platform currently available. A need exists to allow for greater analysis and targeted educational techniques. For example, a need exists for students to access digital platforms where they may engage in quizzes, tests, etc. and experience an overall more interactive form of learning. A need exists also for instructors to be able to use various online collaboration tools that may decrease dependency on traditional paper methods. Instructors are able to use various online tools that conduct short quizzes and send the results back to the instructors for analysis.

### SUMMARY OF THE INVENTION

In some embodiments, disclosed herein is a system for enhanced learning, comprising: a database of educational materials; a portal for instructors comprising; a portal for learners comprising a viewer screen, a Notebook, links to self-assessment, and a link to a marketplace; a marketplace to purchase educational materials; a communication portal between a first instructor and a first learners; a communication portal between a first learner and a second learner; an assessment tool, wherein said assessment took provides analytic data feedback of a learner to an instructor. In some aspects, the system further comprises text-based analytics. In some aspects, the system further comprises a method for commerce of educational content, the method comprising executing on a processor the steps of: a first user utilizing a web-based user interface to prepare electronic educational materials in a computing device; said first user using said web-based user interface to save said notes on computer memory; providing a link on said web-based user interface for said user to sell said notes in a computer store, wherein said user interface used to prepare electronic notes in a computing device comprises a visual aid to click to distribute said notes in a marketplace. In some aspects, the system further comprises educational materials distributed by selling. In some aspects, the system further comprises educational materials that are sold to two or more users. In some aspects, the system further comprises a second set of educational materials is prepared and uploaded to said computing device. In some aspects the system further comprises tracking a second user who accesses said educational materials from said marketplace. In some aspects, the system further comprises providing a communication portal for said first user and said second user to communicate about said educational materials.

In some embodiments, disclosed herein is a system useful in real-time student assessment, the system comprising: a first assessment tool comprising a processor that calculates the amount of time a student spends on a web-page; transmitting the calculated time to a server, wherein the server comprises a central processing unit (CPU); and a second assessment tool comprising displaying at least one visual representation of a pre-determined self-assessment tool to said student; and gathering and transmitting data from said assessment tools and saving said data to a server. In some aspects, the system further comprises sending said data to an instructor. In some aspects, the system further comprises a marketplace. In some aspects, the instructor can recommend educational materials to the student based on said self-assessment. In some aspects, the system further comprises a notebook. In some aspects, the system further comprises text analytics. The system further comprises at least one assessment selected from the group consisting of: a quiz, a test, a worksheet, a homework set, and any combination thereof.

In some embodiments, disclosed herein is a method of providing targeted, evidence-based analytics to improve learning, comprising: monitoring learner interactions with the digital content on a user interface by an instrumented content access platform; capturing raw events generated from learner interaction with educational content through said instrumented content access platform; detecting raw event patterns generated from learner interaction with educational content through said instrumented content access platform over a plurality of users; transforming the raw event patterns of learner interactions, into a set of dynamic states representing learner experience and performance, and associating the set of dynamic states with a respective logical content module; and providing customized educational materials to said learner based on said respective logical content module. In some aspects, the method further comprises a marketplace. In some aspects the method further comprises a communication portal for said first user and said second user to communicate about said educational materials.

In some embodiments, disclosed herein is a system useful for taking notes on course pack materials, the system comprising: a Notebook wherein a learner can mark up and/or take notes; and a course pack comprising educational materials wherein said learner can mark up (e.g. mark up comprises a function selected from the group: highlighting, underlining, drawing, annotations, strikethroughs, italicization, altering the colors of font, altering the colors of a figure, altering the size of font, altering the size of a figure, and any combination thereof). In some aspects, the system further comprises text-based analytics. In some aspects, said learner can move a note or tag from said Notebook to said course pack. In some aspects, said learner can move a note or a tag from said course pack to said Notebook.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an exemplary illustration of a user interface (UI) flow chart for student users, e.g. where students can access information.

FIG. 2 is an exemplary illustration of an embodiment of text/content input feature, e.g. navigation inside an exemplary Course Pack page.

FIG. 3 is an exemplary illustration of a process flowchart for a document viewer, e.g. a Notebook page.

FIG. 4 is an exemplary illustration of data input for the generation and storage of analytical information.

FIG. 5 is an exemplary illustration of the process and information flow for data.

FIG. 6 is exemplary illustration depicting a pop-up function, e.g., inside of a student document viewer.

FIG. 7 is an exemplary illustration of the marketplace (e.g., user-to-user).

### DETAILED DESCRIPTION OF THE INVENTION

Disclosed herein is a system (e.g. web-based platform) for improvement of education comprising aspects including: a platform that is suitable for delivery and distribution of educational materials, a platform for taking notes, a platform for gathering data and analytics on learners' performance, and assessment of a learner's learning. The system can provide more efficient solutions for exchange of educational materials, e.g. in a marketplace in order to better correlate price with utility. The system can provide an improved platform for taking, storing and/or selling notes (e.g. the Notebook). The system can gather data and analytics on both an individual learner's progress and data and analytics on a group of learners' progress. The system can provide assessment of a learner's learning, throughout the course of learning.

The system provides a platform that can facilitate distribution and/or delivery of educational materials, and the like, between users. Educational materials can be exchanged between users through a variety of mechanisms, e.g. instructor to instructor, student to student, instructor to student, student to instructor and the like. Educational materials can be exchanged in a marketplace, wherein one user buys educational materials and another user sells educational materials. In one non-limiting example, a student can sell educational materials they have prepared (e.g. study guides, cheat sheets, diagrams, class notes, outlines, class projects and the like) to another student. In another non-limiting example, an instructor can prepare and sell educational materials to students (e.g. course packets, written materials, and the like). Educational materials can be exchanged via short term rentals (both online and/or printed materials). Educational materials (e.g. books), may be purchased with access to an online platform comprising a marketplace where users can view a digital copy of the book and/or view additional educational materials. Instructors can develop course packs that only consist of content needed by their students. The course packs can be a replacement and/or complement to traditional textbooks.

Educational materials can comprise any material, item, product, collection of information, database, learning object, learning module, assessment, game, and the like that is used for educational purposes (e.g., for a learner to learn material). Some non-limiting examples of educational material can include: books, articles, course packs, study guides, cheat sheets, diagrams, class notes, outlines, class projects videos, media, projects, slides, lectures, flashcards, summaries, outlines, games, worksheets, homework, quizzes, model answers, hypotheticals, case studies, test preparation programs, reports, data, spreadsheets, illustrations, written content, graphs, packets, movies, music, examples, recordings, exercises, pictures, simulations, games, songs, and the like. Educational materials can also comprise data on the learner, including assessments and analytics gathered while the learner accesses the material (e.g., time spent reviewing a page of material). Educational materials can exist in digital format or in some instances can be converted to digital format. Educational materials can exist in a printed paper format or other non-digital format such as braille, audio cassette tape, VHS, and the like. Educational materials can include anything that can be detected by the senses, including audio, visual and/or tactile components.

In some embodiments, the educational platform can identify and provide specific educational content to a learner (e.g., a student) based on many factors, including preferences assessment, and/or other feedback. The platform can comprise an assessment to determine a learner's preferred and/or most efficient or robust learning style. In a non-limiting example, if a student preferred audio-based learning an audio format could be provided. In another non-limiting example, if a student preferred a tactile format, braille could be provided. In another non-limiting example, if a student preferred visual learning, illustrations and written content could be provided. In another non-limiting example, if an assessment showed that the learner learned better using a combination of video and written content, customized content could be provided. The platform represents an informational model where content developers can create educational materials (e.g. course materials) that can be then distributed to consumers (i.e. users, students and the like) based on factors (e.g. preferences and/or assessments) that optimize learning for the learner.

In some embodiments of the system, there exists an instructor portal for a user to access the platform. By using the instructor portal, a user can view, upload, create, edit, modify and/or delete educational materials. By using the instructor portal, a user can review data, assessments, assignments, and/or analytics from users who are learners (e.g., students). Instructors may from time to time add, edit, modify or remove content that is posted within a course module, including not limited to editing educational materials such as quizzes, worksheets, homework and the like. In some embodiments of the system, a user can use the instructor portal to create, edit, or delete quizzes that appear in a course pack. In some non-limiting examples, users who use the instructor portal can add, edit or delete questions in tests or quizzes (e.g. true or false, multiple choice with one correct answer, multiple choice with multiple correct answers, and short answer questions). In some embodiments, by using the instructor portal, a user can upload or generate materials to exchange in the system's marketplace.

In some embodiments of the system, there exists marketplace for educational materials. Educational materials can be exchanged in the marketplace. An exchange can occur between users of the system (e.g. learner to learner, instructor to learner, learner to instructor and the like). In some embodiments, educational materials are sold. The selling of educational materials can be accomplished using any format of payment, including credit card, debit card, gift card, point accumulation, online payment system (e.g. PayPal and the like), digital wallet (e.g. Venmo and the like), via one or more currency (e.g. a US or foreign currency or via a crypto or block chain currency). In some embodiments, educational materials are exchanged in a barter fashion (e.g. a first user exchanges notes with a second user for a second user's notes). In some embodiments, educational materials are exchanged at no cost, e.g. pro bono.

In some embodiments of the system, information is gathered on the users. For example, the system can gather data on a learner's use of the system (e.g. score on an assessment, time spent reading material, etc.). In some embodiments, real-time data can be generated using the platform. Data can processed to provide further data (e.g. analytics and/or statistics) and/or raw data can be used. Data (in any format) can be used by instructors. Data can be used to aid instructors in the further development of the instructor's educational materials and/or to influence teaching methods. Data can be used to suggest further educational materials for a learner to use to better master the material (e.g. for the learner to achieve the learning goals and/or objectives). Data can be used to improve the system. Data can be used to inform the learner about their learning style and/or to improve learning outcomes.

In some embodiments of the system, digital programming of the one or more platforms can ensures real-time communication between some or all users. This tool allows collaboration between users. In some embodiments, the communication between users can facilitate the marketplace. In some embodiments, the communication between users can facilitate learning goals and/or objectives.

In some embodiments of the system, there exists a gating function. A gating function can allow the instructor to require a student achieve a grade above a set threshold before the student may move on to any future sections, materials and/or quizzes. A gating feature may also be activated such that a student must read a section, chapter, and/or document or other educational material before the student may proceed to the next section, chapter, document, quiz or educational material.

In some embodiments of the system, educational materials and content created, saved, linked to and/or uploaded within a user's portal can be saved on a backend database. In some embodiments, users can be given the option to download the content, e.g. to their personal devices such as a computer, smart phone, tablet, laptop and the like. This can facilitate a user using the educational materials offline. In some embodiments of the system, educational material can be printed. In some embodiments, different content can have different access levels (e.g. view online digital copy only, access to print, access to download to personal device).

The system can comprise a document viewer. The functionalities of the document viewer can include, but are not limited to, various digital formats such as: PDF, text, MS word, jpeg, and the like. The document viewer can comprise: scaling and drag functionalities to assist in viewing the digital content, navigational assistance in order to aid the use of lengthy documents, built-in text input mechanism for the purpose of marking up and notetaking by the users, tools that allow interactions with text and figures, including but not limited to: highlighting, redacting, strikeout, copying text, pasting text, and select text, drawing tools to further aid visual learning, changing the size and/or color of drawings and/or text, underlining, drawing, annotating strikethrough, italicization, and any combination thereof.

In some embodiments of the system, a section titled “Notebook” is constructed to assist direct communication between users. Utilizing the Notebook does not require ownership of educational material. The Notebook contains content that can be linked to specific content material. This section of the platform includes a built-in application that further allows communication between all parties.

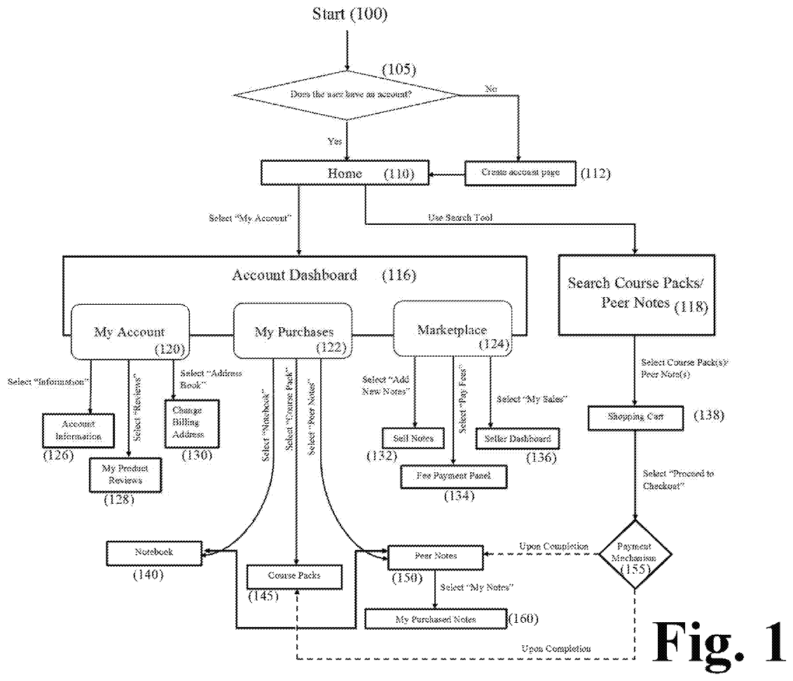

FIG. 1 depicts a flowchart illustration of the user interface for which students can access their information. In some implementations, the software can start (100) by asking Whether the User has an Account (105). If the answer is no, the user can be brought to a page to Create an Account (112). Upon completing the creation of the account, the user can reach the Home Page (110), which is where the user would have went if the user already had an account. From the Home Page (110), the user can perform various tasks including using the search tool, which allows the user to search Course Packs and Peer Notes (118). The user can then select the course pack or peer notes the user wants and put the material in the Shopping Cart (138). After selecting a proceed to checkout button, the user will be redirected to a Payment Mechanism (155). After completing the payment, the user may access the Peer Notes (150) or Course Packs (145) that were purchased.

On the Home Page (110), the user can also select the My Account link leading to the Account Dashboard (116). From the Account Dashboard (116), the user can go to the Marketplace (124), the My Purchases (122) page, or the My Account (120) page. The Marketplace (124) has a Sell Notes (132) link, where the students can sell their notes to their peers. The Marketplace (124) also has a Fee Payment Panel (134) for the user to look at and pay outstanding fees. And the Marketplace (124) has a link to the Seller Dashboard (136) allowing the user to view past sales of their notes.

The My Account (120) link allows users to view Account Information (126), look at Product Reviews (128) for their particular products, and change account information including Changing Billing Address (130). The functions of the My Account (120) page relates to information gathered from or given by that specific user.

The My Purchases (122) page provides links for the user to view their individualized Notebook (140), their Course Packs (145), and their Peer Notes (150). The My Purchases (122) page contains a majority of the content needed for the course. The Peer Notes (150) page includes a link to the My Purchased Notes (160) page, which includes all notes acquired through the shopping function. The Peer Notes (150) page also contains a link to the Notebook (140).

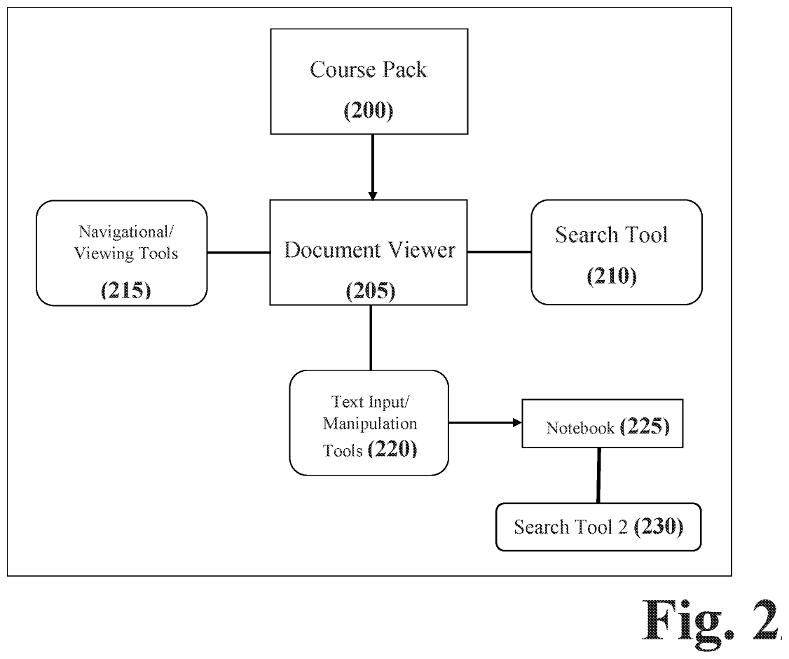

FIG. 2 depicts an exemplary flowchart of the navigation inside the Course Pack page. In some implementations the user will go to the Course Pack (200), where the user can access the Document Viewer (205). While in the Document Viewer (205), the user will view various items in the course pack, and the user will be able to use to Search Tool (210), Navigational/Viewing Tools (215), and the Text Input/Manipulation Tools (220). The Search Tool (210) can allows the user to search throughout the document for certain words, numbers, letters, and phrases. The search can be specific, such as a find function. The Navigational Tools (215) include various ways of finding and going through the material without having to scroll through the whole document. The Text Input/Manipulation Tools (220) allows the user to perform various tasks, including but not limiting highlighting, striking through, and drawing on the text (215). The Notebook (225) can also comprise a Search Tool. The Search Tool can comprise a general search, and can search more broadly the Notebook, the course pack, and other electronic files in the marketplace and/or other educational materials in the system that the learner has access to.

In some embodiments of the system, a user can have their own customized section of materials, sometimes termed a Notebook section. The Notebook section can comprise materials marked public or private. The functionalities of the Notebook section can include, but are not limited to: ability to search and sort through content, an “add” feature for the purposes of, but not limited to, seeking assistance, writing notes, and creating flashcards. The system can further comprise a feature that allows users to download Notebook content for offline use. The system can further comprise a comment feature to allow interaction between users on the content.

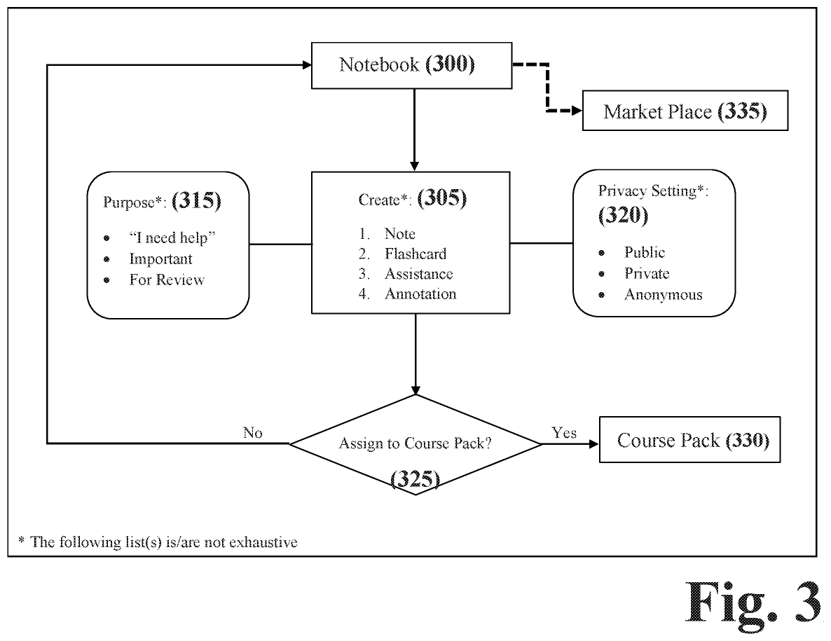

FIG. 3 illustrates exemplary uses for an example user Notebook page. In some implementations, the Notebook (300) affords the user the opportunity to Create (305) material of some sort. The material could be notes, flashcards, assistance, annotations, or other useful material that would aid in the user's learning. Inside the Create (305) function, the user can choose the Privacy Settings (320) and the Purpose (315) (e.g. tagging) for the created material. The Privacy Settings (320) could be and are not limited to public, private, and anonymous. The Purpose (315) (i.e. tag) can be set to any useful tag, some non-limiting examples include: “I need help,” “important”, “for review”, or any other indicator that would help the user. Once the material is created he material can be saved on the server and then the user can assign (325) the material either to the Course Pack (330) or the Notebook (300). The Notebook (300) can also, optionally, link with the marketplace.

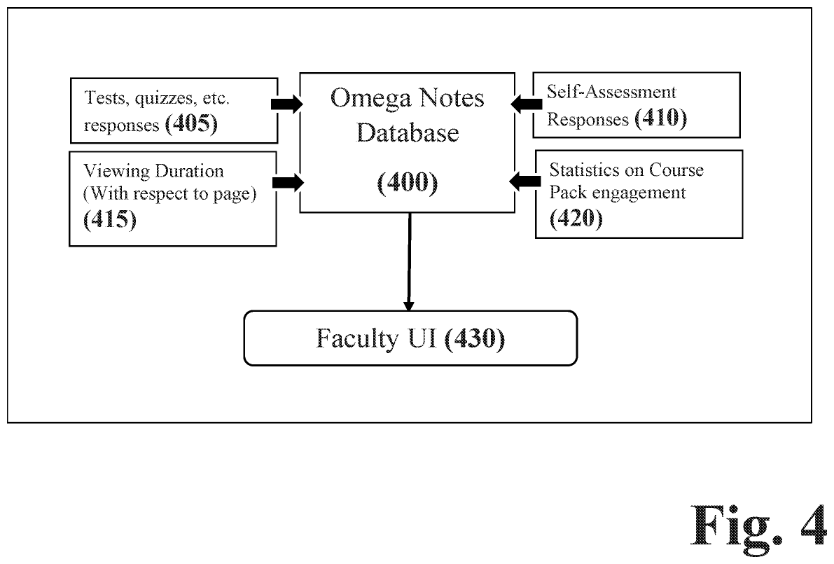

FIG. 4 illustrates exemplary information that can be stored, moved and processed in the system. In some embodiments, the Database (400) can store Responses for Tests, Quizzes, and the like (405); Self-Assessment Responses (410); Viewing Duration (415); and Statistics on Course Pack Engagement (420). The Database (400) can store the data in an organized manner, and the Database (400) can provide the information to the Faculty User Interface (UI) (430) (e.g. instructor user interface).

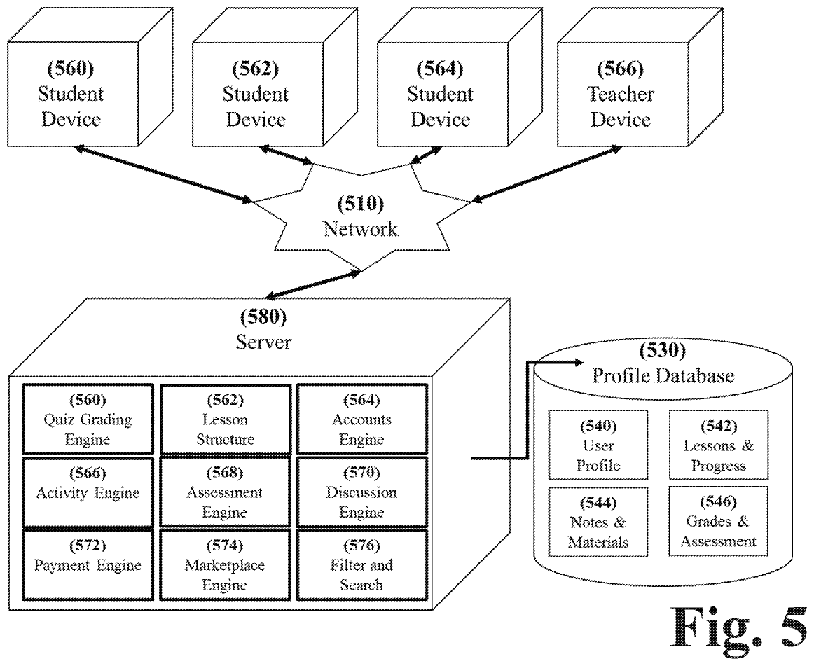

FIG. 5 illustrates an exemplary embodiment of the system. In some embodiments, learner devices (e.g., Student Devices (560) (562) (564)) and instructor devices (e.g., Teacher Devices (566)) can communicate with a Network (510), which can put the users into communication with a server (580). The Server (580) can include various engines and information, including a Quiz Grading Engine (560), a Lesson Structure Engine (562), an Accounts Engine (564), an Activity Engine (566), an Assessment Engine (568), a Discussion Engine (570), a Payment Engine (572), a Marketplace Engine (574), and a Filter and Search Engine (576). The Server (580) also stores the information for the Profile Database (530) which includes information on User Profiles (540), Lessons & Progress (542), Notes & Materials (544), and Grades & Assessments (546). Through the Network (510) the users can add to and look back on their information in the Server (580).

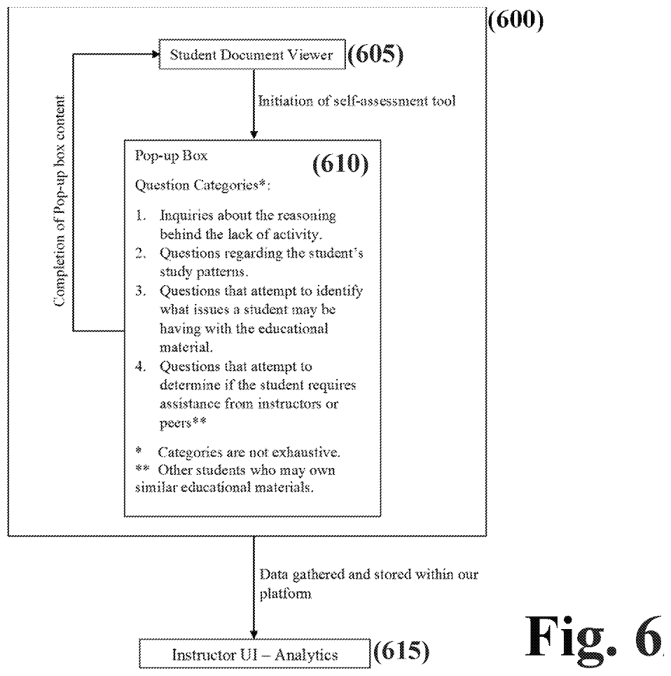

FIG. 6 depicts a pop-up function inside of the student document viewer. In some implementations, a system (600) for self-assessment pop-ups exists in a student document viewer (605). A student document viewer (605) can be set so that the self-assessment tool may be initiated due to time spent on subject or other factors. When the tool is initiated, a pop-up box (610) can appear with various question categories including but not limited to inquiries about the reasoning behind the lack of activity, questions regarding the student's study patterns, questions that attempt to identify what issues a student may be having with the educational material, and any other type of question that could attempt to determine if the student requires assistance from instructors or peers. The assessment tool can have one or more questions. The help from peers could involve help from other students who use the same or similar educational materials. Once the assessment questions are completed, the user will be redirected back to the Student Document Viewer (605). The information obtained from the questions will be gathered and stored. The stored data will be sent to the Instructor User Interface (UI)—Analytics (615). A final assessment can be taken after the learner has completed the task in the viewer. The final assessment could encompass 1 or more questions.

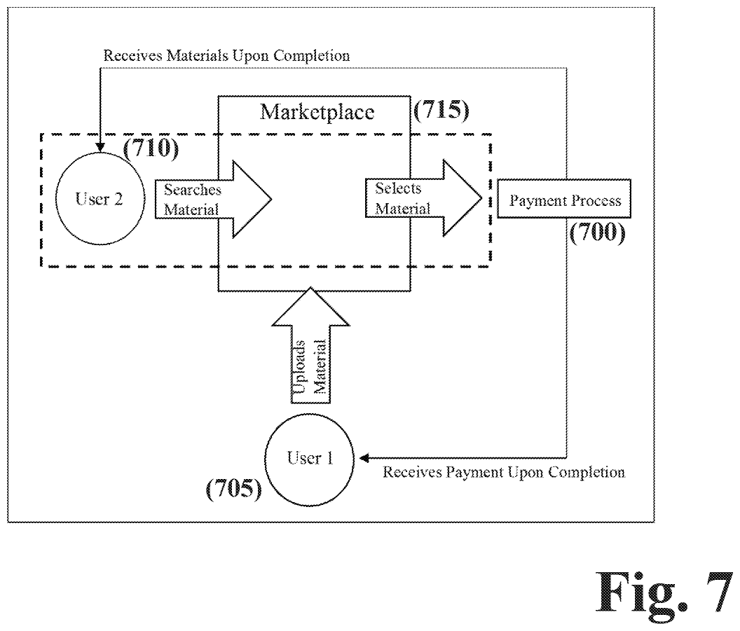

FIG. 7 depicts a peer to peer marketplace. In some embodiments, the system will comprise a Peer to Peer Marketplace (715). In an example, a seller (705), user 1, can upload material to the marketplace (715). The buyer (710), user 2, can search materials on the marketplace (715) and select materials. The buyer (710) can go through the payment process (700). Once the payment process (700) is completed, the seller (705) can receive payment, and the buyer (710) can receive the material.

In some embodiments of the system, the integrated platform allows content sharing between the document viewer and Notebook section. The document viewer can provide a content feed to the Notebook. Content can be automatically inputted to, and, optionally, publicly displayed on the Notebook upon creation. In addition, users have the ability to collaborate through publicly shared content. Additionally, content that is created within the Notebook can be assigned to a specific course pack, and/or a specific chapter within the course pack, and/or a specific page of a chapter within the course pack.

In some embodiments, the system is comprised of a marketplace for the exchange of educational material by users. The marketplace is integrated with the overall platform as described herein.

In some embodiments of the device, students to upload educational material in formats including but not limited to .pdf, .jpg, .jpeg, .png, etc. and assign specific details to the material, the details include, but are not limited to, Name, University, Class, Description and Price.

In some embodiments of the device, a tool to search through uploaded material and a preview feature that allows users to view a select section of the material. Additionally, uploaded material can be rated and reviewed by its respective buyers.

In some embodiments of the device, a payment method, embedded within the platform that assists monetary transactions between the seller, the platform and the buyer.

In some embodiments of the device, a mechanism for the delivery of educational material upon purchase. In some implementations this may include a download option for peer-to-peer marketplace material.

In some embodiments of the device, the feedback mechanism utilizes a proprietary user interface (FIG. 4) and is dedicated for instructors.

In some embodiments of the device, instructors can monitor student activity with respect to specific content viewed in a Course Pack content file which may consist of multiple pages. Instructors will have access to data on each users as to how many times each page is viewed by individual users, each set of pages is viewed by individual users and section is viewed by individual users. Additionally, instructors are provided with the identity of the user who is active on the course pack in real-time.

In some embodiments of the device, instructors can monitor duration of content viewership by individual users. Instructors can access data with the amount of time an individual user has spent on a specific part of the educational material.

In some embodiments of the device, instructors can interact with specific course material. Instructors are made aware of all interaction with specific educational material that takes place within the document viewer by the individual users.

In some embodiments of the device, instructors can monitor real-time data on student responses. The data accessible to instructors includes, but is not limited to, requests for help, results of online quizzes, and the outcome of online exams.

In some embodiments of the device, instructors can monitor real-time result of student self-assessments. A feature built in to the document viewer can pop up which is designed to initiate when a user spends an abnormal amount of time on a specific page. Abnormal amount of time can be either too short, as defined by the instructor in seconds, minutes, hours, days, or the amount of time can be too long, as defined by the instructor in seconds, minutes, hours, days. Once the self-assessment is initiated, the user is prompted to complete a short assessment. The instructor can access the data gathered from this assessment and use the data as the instructor sees fit to incorporate into the lesson. Specifics of the self-assessment tool are detailed in FIG. 6.

In some embodiments of the device, self-assessments can appear within the viewer randomly within a set time parameter.

In some embodiments of the device, there exists a self-assessment at completion of the section. Upon a user signifying he/she has completed the chapter and/or section, the user will be prompted to complete a self-assessment.

In some embodiments of the device, instructors can monitor micro and macro forms of accessible data. The platform provides instructors with data that is compiled from all students that have purchased content linked to the instructor.

In some embodiments of the device, there is an option to expand on the macro data in order to find specifics regarding the data sets of individual students.

While preferred embodiments of the present invention have been shown and described herein, it will be obvious to those skilled in the art that such embodiments are provided by way of example only. It is important to note that the features and actions described herein can be conducted simultaneously or independently at a given time. Numerous variations, changes, and substitutions will now occur to those skilled in the art without departing from the invention (e.g. capitalized terms used herein may be referred to by different names). It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of providing targeted, evidence-based analytics to improve learning, comprising:
providing, via graphical user interface, access to educational content to a first user;
monitoring, via a processor, a raw event pattern generated from the interaction of the first user with the educational content, wherein the raw event pattern is selected from the group consisting of the time the first user spends viewing a portion of the educational content, the location of the cursor on the educational content, and the closing of the educational content via the graphical user interface;
providing, via the graphical user interface, a first assessment tool comprising a visual representation containing one or more questions for the first user, the questions based on the raw event pattern;
recording, via the processor, the response of the first user to the one or more questions;
providing, via the graphical user interface, customized educational content based on the raw event pattern and the response.

2. The method of claim 1, further comprising a marketplace.

3. The method of claim 1, further comprising a communication portal for said first user and a second user to communicate about said educational materials.

4. The method of claim 1, further comprising sending said data to an instructor.
